(19) United States
(12) Patent Application Publication
(10) Pub. No.: US 2011/0056388 A1
(43) Pub. Date: Mar. 10, 2011

(54) FOOD PROCESSOR

(75) Inventor: Congjie LIN, Zhangzhou (CN)

(73) Assignee: Tsann Kuen (Zhangzhou) Enterprise Co., Ltd., Fujian Province (CN)

(21) Appl. No.: 12/878,103

(22) Filed: Sep. 9, 2010

(30) Foreign Application Priority Data
Sep. 9, 2009 (CN) 200920310002.5

(51) Int. Cl. A47J 27/04

(52) U.S. Cl. 99/474; 99/477; 126/20

(57) ABSTRACT

A food processor has a base seat; a processing chamber installed on the base seat; a rotary roller for containing food, which is driven by a motor and rotablely disposed in the processing chamber and cooperate with said processing chamber coaxially; a steam generating unit is installed in the base seat, the steam outlet of the steam generating unit stretches into the processing chamber. Steam is used to heat and cook the nuts, frozen food and other food, because of the rotary roller, the rotation of the rotary roller can drive the hot steam to be fully distributed in the whole processing chamber. The surface of the food can fully contact the hot steam. The food is heated and cooked evenly, the processing speed is quicker, and the taste is unified.

### FIELD OF THE UTILITY

The present utility relates to a food processor, especially relates to a small size food processor suitable for cooking nuts, frozen food and so on.

### BACKGROUND OF THE UTILITY

In the existing technique, it usually use grilling or frying manners to cook the nuts, frozen foods and other foods, however it is not healthy to cook by frying, and the food will not be heated evenly by the grilling manner, so the processing speed is relatively low, the energy may be wasted. So there is a steam manner, however, because the steam usually moves upward automatically, so the energy will be wasted.

### SUMMARY OF THE UTILITY

The main object of the present utility is to overcome the drawback of the existing technique, and to provide a small size food processor which utilizes a steam heating manner, the nuts, the frozen food and other food can be cooked.

The technique solution applied by the present utility is:

A food processor, it comprises:

a base seat;

a processing chamber installed on said base seat;

a rotary roller for containing food, said rotary roller is driven by a motor and is rotablely disposed in said processing chamber and cooperate with said processing chamber coaxially;

a steam generating unit installed in said base seat, the steam outlet of said steam generating unit stretches into said processing chamber.

According to a preferred embodiment of the present utility, said steam generating unit comprises a water box, a pump and a steam generator, said pump is connected to said water box and said steam generator with a water inflow pipe, said steam generator is connected to said processing chamber with a steam output pipe, said steam output pipe has said steam outlet.

According to a preferred embodiment of the present utility, said base seat is a U-shaped structure, which comprises a level main body, two side walls and a retaining space between the two side walls, said processing chamber is installed in said retaining space.

According to a preferred embodiment of the present utility, said water box is disposed on a side wall of said base seat.

According to a preferred embodiment of the present utility, the upper part of said processing chamber has a handle.

According to a preferred embodiment of the present utility, said rotary roller is fixed with a rotary shaft, an end of said rotary shaft is fixed on an output gear of said motor.

According to a preferred embodiment of the present utility, said processing chamber has a transparent portion.

Referred from the above description of the present utility and compared to the existing technique, the food processor of the present utility has such advantages:

Firstly, the present utility applies steam to cook the nuts, frozen foods such as chips and other food, because of the rotary roller, so the rotation of the rotary roller can drive the hot steam to be fully distributed in the whole processing chamber, so the surface of the food can fully contact with the hot steam, the food is evenly heated, the cooking speed is quicker, the doneness of the food is unified, the taste is unified, too, thereby to acquire an intelligent and power-saving effect.

Secondly, the base seat is a U-shaped structure, it comprises a level main body, two side walls and a retaining space between the two side walls, the processing chamber is installed in said retaining space, the design is unique and beautiful;

Thirdly, a transparent portion is disposed on the processing chamber, the user can observe each cooking process such as the rotation of the rotary roller through the transparent portion, so the food processing is more interesting.

### BRIEF DESCRIPTION OF THE DRAWINGS

FIG. 1 is a partial exploded structural view of a food processor of the present utility;

FIG. 2 is a sectional structural view of a food processor of the present utility.

### DETAILED DESCRIPTION OF THE EMBODIMENTS

The present utility will become apparent with the reference of the detailed description of the embodiments.

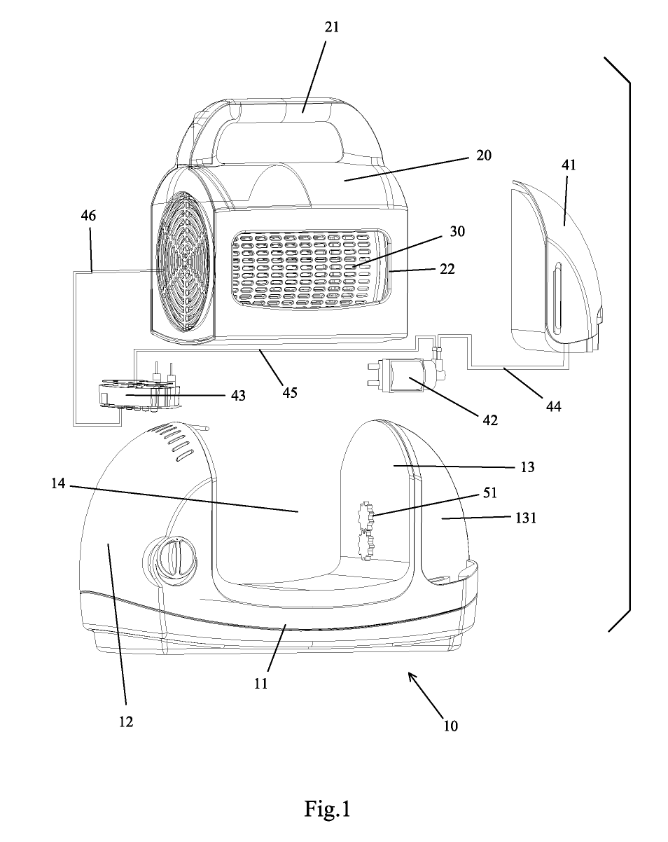

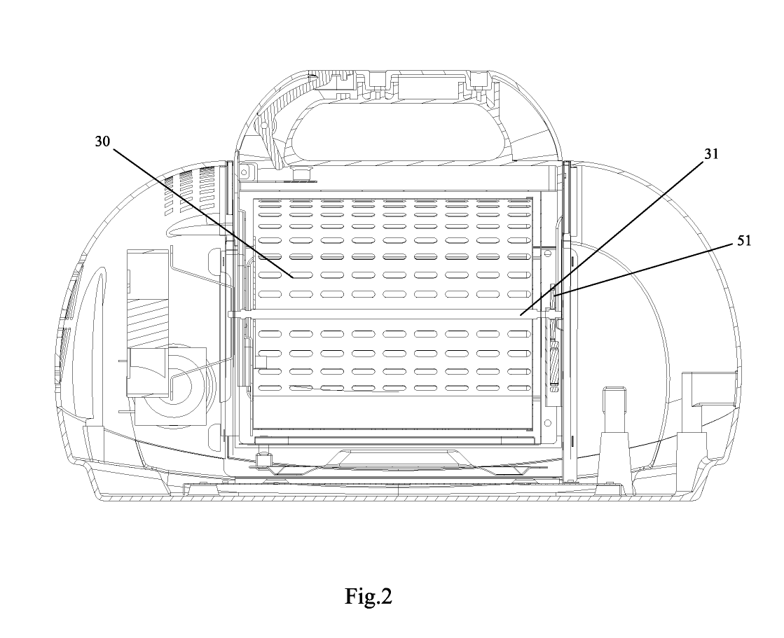

Please refer to FIG. 1 and FIG. 2, the food processor of the present utility comprises a base seat 10, a processing chamber 20, a rotary roller 30 and a steam generating unit, said processing chamber 20 is installed on the base seat 10, the rotary roller 30 is driven by a motor and rotablely disposed in the processing chamber 20 and cooperated with the processing chamber 20 coaxially, the steam generating unit is installed on the base seat 10.

The base seat 10 is a U-shaped structure, it comprises a level main body 11, two side walls 12,13 and a retaining space 14 between the two side walls 12, 13, the processing chamber 20 is installed in the retaining space 14.

The processing chamber 20 has a handle 21 and a transparent portion 22, the rotation process of the rotary roller 30 can be observed through the transparent portion 22.

The steam generating unit comprises a water box 41, a pump 42 and a steam generator 43, said pump 42 is connected to the water box 41 with a water inflow pipe 44, said pump 42 is connected to the steam generator 43 with a water inflow pipe 45, said steam generator 43 is connected to the processing chamber 20 with a steam output pipe 46, so the steam generated by the steam generator 43 is sprayed into the processing chamber 20 and the rotary roller 30 with the steam output pipe 46. The water box 41 is disposed on a retaining space 131 of the side wall 13.

A rotary shaft 31 is fixed on the rotary roller 30, an end of said rotary shaft 31 is fixed on an output gear 51 of the motor.

When the food processor of the present utility is during operation, the hot steam generated by the steam generating unit will be transmitted into the processing chamber 20 and the rotary roller 30, at the same time, the motor will drive the rotary roller 30 rotate in the processing chamber 20, so the hot steam of the processing chamber 20 and the rotary roller 30 will be distributed to every corner of the processing chamber 20 and the rotary roller 30, so the surface of the food can fully contact with the hot steam, the food will be heated more evenly, the processing speed is quicker, the doneness of the food is unified, the tasted is unified, too, thereby the energy is saved, it is widely and suitable for cooking nuts, frozen food and other food, the cooking process is accelerated, it is convenient, diversification and household applicable.

Although the present utility has been described with reference to the preferred embodiments thereof for carrying out the utility, it is apparent to those skilled in the art that a variety of modifications and changes may be made without departing from the scope of the present utility which is intended to be defined by the appended claims.

What is claimed is:

1. A food processor, wherein it comprises:
a base seat;
a processing chamber installed on said base seat;
a rotary roller for containing food, said rotary roller is driven by a motor and is rotablely disposed in said processing chamber and cooperate with said processing chamber coaxially;
a steam generating unit installed in said base seat, the steam outlet of said steam generating unit stretches into said processing chamber.

2. The food processor according to claim 1, wherein said steam generating unit comprises a water box, a pump and a steam generator, said pump is connected to said water box and said steam generator with a water inflow pipe, said steam generator is connected to said processing chamber with a steam output pipe, said steam output pipe has said steam outlet.

3. The food processor according to claim 2, wherein said base seat is a U-shaped structure, which comprises a level main body, two side walls and a retaining space between the two side walls, said processing chamber is installed in said retaining space.

4. The food processor according to claim 3, wherein said water box is disposed on a side wall of said base seat.

5. The food processor according to claim 1, wherein the upper part of said processing chamber has a handle.

6. The food processor according to claim 1, wherein said rotary roller is fixed with a rotary shaft, an end of said rotary shaft is fixed on an output gear of said motor.

7. The food processor according to claim 1, wherein said processing chamber has a transparent portion.

8. The food processor according to claim 2, wherein the upper part of said processing chamber has a handle.

9. The food processor according to claim 3, wherein the upper part of said processing chamber has a handle.

10. The food processor according to claim 4, wherein the upper part of said processing chamber has a handle.

11. The food processor according to claim 2, wherein said rotary roller is fixed with a rotary shaft, an end of said rotary shaft is fixed on an output gear of said motor.

12. The food processor according to claim 3, wherein said rotary roller is fixed with a rotary shaft, an end of said rotary shaft is fixed on an output gear of said motor.

13. The food processor according to claim 4, wherein said rotary roller is fixed with a rotary shaft, an end of said rotary shaft is fixed on an output gear of said motor.

14. The food processor according to claim 2, wherein said processing chamber has a transparent portion.

15. The food processor according to claim 3, wherein said processing chamber has a transparent portion.

16. The food processor according to claim 4, wherein said processing chamber has a transparent portion.
